(19) United States
(12) Patent Application Publication
(10) Pub. No.: US 2012/0298113 A1
(43) Pub. Date: Nov. 29, 2012

(54) Restorator chair

(76) Inventor: Ryan Hruska, Omaha, NE (US)

(21) Appl. No.: 13/068,993

(22) Filed: May 25, 2011

(51) Int. Cl. A61G 15/00

(52) U.S. Cl. 128/845

(57) ABSTRACT

A restorator chair which is selectively pivotally movable between a first position, wherein the patient sitting in the chair is in a generally upright position, and a second position wherein the patient is generally in a supine position. The chair includes various pressure sensitive sensors which are actuated when the patient applies pressure thereto. The chair includes a heel rest, a back and arm rest, a right thigh support, a left thigh support, a right leg support having a right foot support at the lower end thereof and a left leg support having a left foot support at the lower end thereof.

### BACKGROUND OF THE INVENTION

1. Field of the Invention

This invention relates to a restorator chair for use in a physical therapy treatment known as Postural Restoration. More particularly, this invention relates to a restorator chair which may be selectively moved 90 degrees from a first sitting position to a second zone restoration position. Even more particularly, this invention relates to a restorator chair which includes pressure sensitive sensors mounted in several positions on the chair.

2. Description of the Related Art

Postural Restoration is a physical therapy treatment approach based on the work of Ron Hruska, MPA, P.T., and it is a neuromuscular retraining of the muscles in the body. This treatment isolates a contraction of the under-used muscles of the body and creates a corresponding inhibition of the opposing hypertonic muscles. Full recovery of length from the hypertonic muscles is expected, and this allows for full flexibility, full ROM, and an ability to recover proper posture/position. When good position is achieved, the pressures within the tissues are minimized and the injured site is returned to the optimal position for healing.

United States Patent Publication No. U.S. 2005/0076922 A1 published Apr. 14, 2005 discloses a postural support therapy wall guard footrest used in postural support therapy exercising related to pelvic femoral positioning. In this publication, the patient is placed in a supine position with the patient's feet positioned against a vertical surface. If the patient is suffering from back or leg problems, it will be extremely difficult to properly position the patient without the patient experiencing severe pain.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A restorator chair is provided for use in practicing a physical therapy treatment known as Postural Restoration. The chair of this invention comprises an elongated base frame having a patient chair frame means pivotally secured thereto which is movable between first and second positions with respect to the base frame assembly. An electrically operated, length adjustable actuator, has one end thereof pivotally connected to the patient chair frame means and its other end pivotally connected to the base frame assembly for pivotally moving the patient chair frame means between its first and second positions. An elongated support post has its lower ends secured to the patient chair frame means and extends upwardly therefrom. A head rest is selectively vertically adjustably secured to the support post adjacent the upper end thereof at the forward side thereof. A back and arm rest is selectively vertically adjustably secured to the support post below the head rest and is spaced therefrom at the forward side of the support post. A lower back support is selectively horizontally secured to the support post at the lower end of the back and arm rest and is spaced therefrom at the forward side of the support post.

A generally horizontally disposed right thigh support is secured to the patient chair frame means at the right side thereof so as to be positioned below the lower back support. A generally horizontally disposed left thigh support is secured to the patient chair frame means at the left side thereof so as to be positioned below the lower back support. The left thigh support is selectively vertically and horizontally adjustably secured to the patient chair frame means. A right leg support assembly is secured to the patient chair frame means and includes a generally horizontally disposed upper portion and a generally vertically disposed portion extending downwardly from the forward end of the horizontally disposed upper portion of the right leg support assembly. The horizontally disposed upper portion of the right leg support assembly is selectively longitudinally horizontally adjustably secured to the patient chair frame means.

A right foot plate assembly including a right foot plate is selectively vertically adjustably secured to the vertically disposed portion of the right leg support assembly so as to extend forwardly therefrom. The right foot plate has a heel support associated therewith. A left leg support assembly including a generally horizontally disposed upper portion and a generally vertically disposed portion extends downwardly from the forward end of the generally horizontally disposed upper portion thereof. The generally horizontally disposed upper portion of the left leg support assembly is selectively horizontally adjustably secured to the patient chair frame means at the left side thereof so as to extend longitudinally forwardly therefrom. A left foot plate assembly including a left foot plate is selectively vertically adjustably secured to the vertically disposed portion of the left leg support assembly so as to extend longitudinally forwardly therefrom. The left foot plate assembly includes a heel support associated therewith.

When the patient chair frame means is in its first position, the head rest, upper back and arm support are in a substantially vertically disposed position with the right and left thigh assemblies being inwardly horizontally disposed when the patient chair frame means is in its first position. When the patient chair frame means is in its second position, the head rest, back and arm rest are in a substantially horizontally disposed position with the right and left thigh supports being in a generally vertically disposed position and with the right and left foot plates being in a vertically disposed position.

A first pressure sensitive sensor is associated with the back and arm rest and a second pressure sensitive sensor is associated with the right thigh support. A third pressure sensitive sensor is associated with the left thigh support and a fourth pressure sensitive sensor is associated with the left heel support. A visual indicator is provided which indicates which of the pressure sensitive sensors have been activated by the patient on the chair when the chair is in its second position.

A principal object of the invention is to provide a restorator chair which permits individuals to activate muscles that will allow them to inhibit muscles that are on secondary to a neurological pattern that the individual is experiencing.

A further object of the invention is to provide a restorator chair which allows patients to find, feel and see that they have facilitated certain muscles and allow them to breathe with those muscles inhibited to allow them to change their present neurological pattern in day to day life.

A further object of the invention is to provide a restorator chair which places an individual in a position that is optimal for inhibition, the individual's present neurological pattern by allowing facilitations of opposing muscle groups.

A further object of the invention is to provide a restorator chair which permits optimal repositioning of a person into a more neutral state and allow the person to feel what it is like to be in such position and train that person in that position.

Still another object of the invention is to provide a restorator chair which enables a person to determine if the person is functioning asymmetrically.

Yet another object of the invention is to provide a restorator chair which enables a person to learn how to live and breathe more symmetrically to achieve a more optimal position.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of the chair of this invention in its first position;

FIG. 2 is a view similar to FIG. 1 except that the chair has been pivotally moved to its second position;

FIG. 3 is a side view of the chair as seen from the left side thereof with the broken lines illustrating the chair being positioned in its second position;

FIG. 4 is a partial exploded perspective view of the base frame assembly;

FIG. 5 is a perspective view of the patient chair frame means and the associated structure thereon;

FIG. 6 is an exploded perspective view of the chair of this invention;

FIG. 7 is a partial exploded perspective view of the chair of this invention;

FIG. 8 is a right side view of the patient chair frame means in its first position;

FIG. 9 is a front view of the chair of FIG. 8;

FIG. 10 is a top view of the chair of this invention in its first position;

FIG. 11 is a partial perspective view of the left leg support and left foot support;

FIG. 12 is a partial exploded perspective view illustrating the support posts, head rest, back and arm support and lower back support;

FIG. 13 is a partial exploded perspective view illustrating the relationship of certain components with respect to the patient chair frame means; and

FIG. 14 is a partial perspective view of a portion of the left thigh support.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The restorator chair of this invention is referred to generally by the reference numeral 10. Chair 10 generally includes the following assemblies, namely a base frame assembly 12, a patient chair frame means 14, support post or column 16, head rest 18, upper back and arm support 20, lower back support 22, right thigh support 24, left thigh support 26, right leg support 28, left leg support 30, right foot support 32, left foot support 34 and visual indicator 36.

Base frame assembly 12 will be described as having a rearward end 38, forward end 40, right side 42 and left side 44. Base frame assembly 12 has a pair of upright supports 46 and 48 between its forward and rearward ends. Base assembly 12 has a back wall 50 which has a mounting bracket 52 secured to the forward side thereof. The rearward end 54 of an electric screw actuator 56 is pivotally secured to bracket 52 about a transverse horizontal axis.

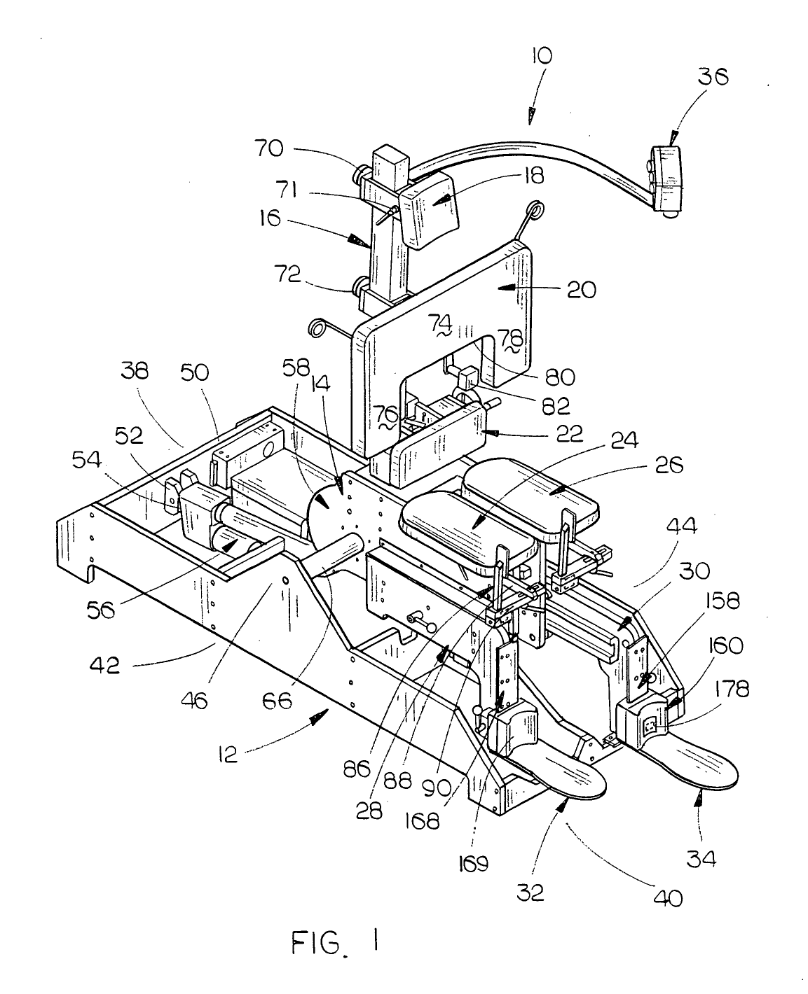

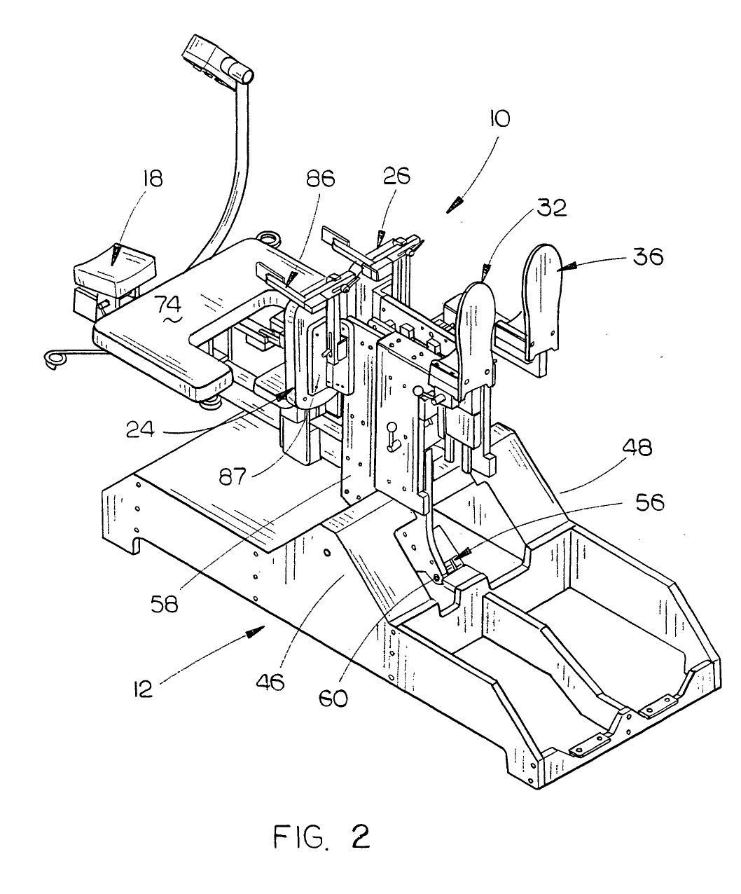

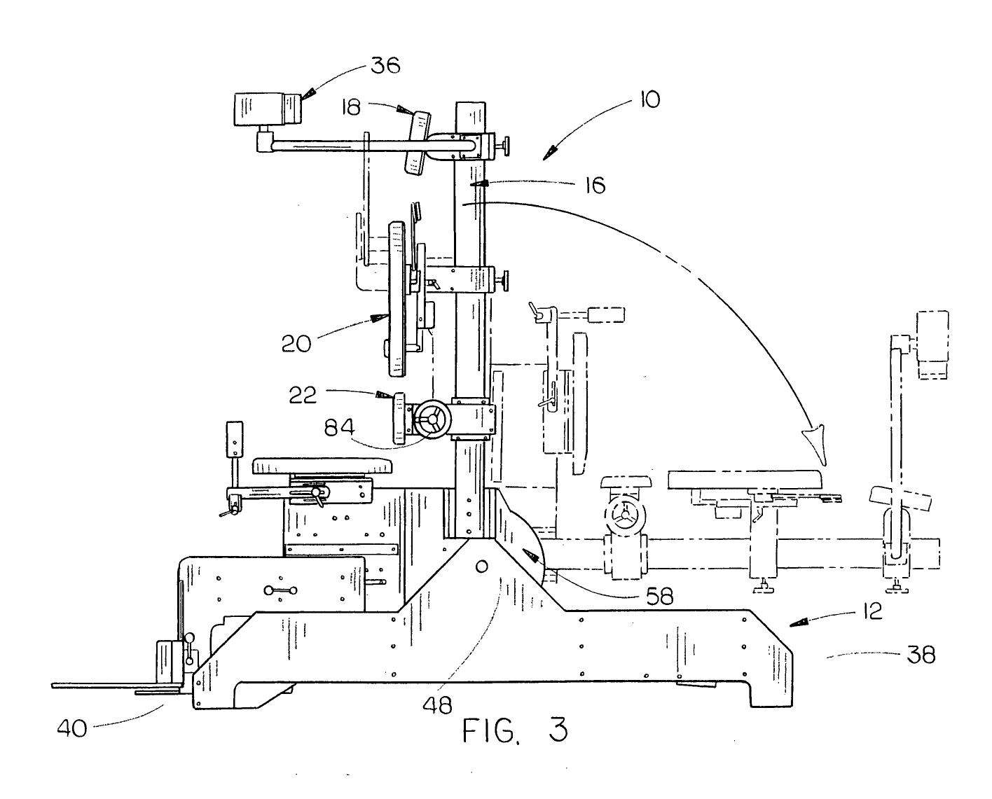

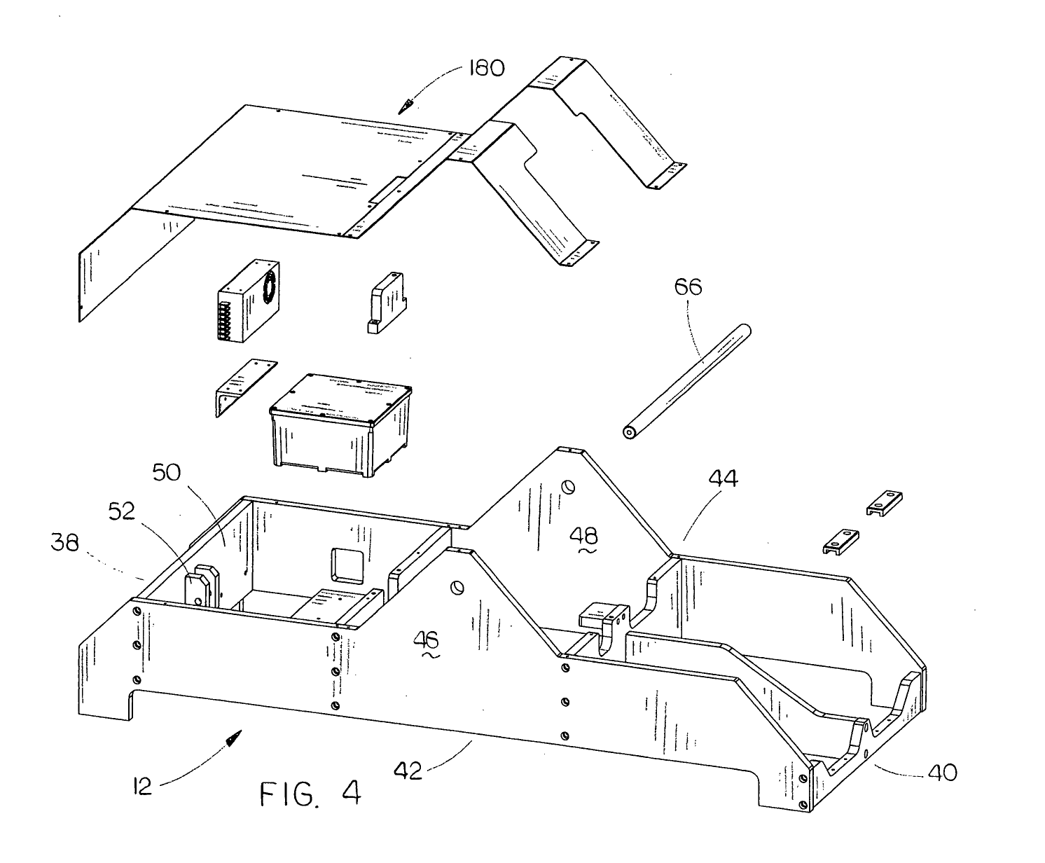

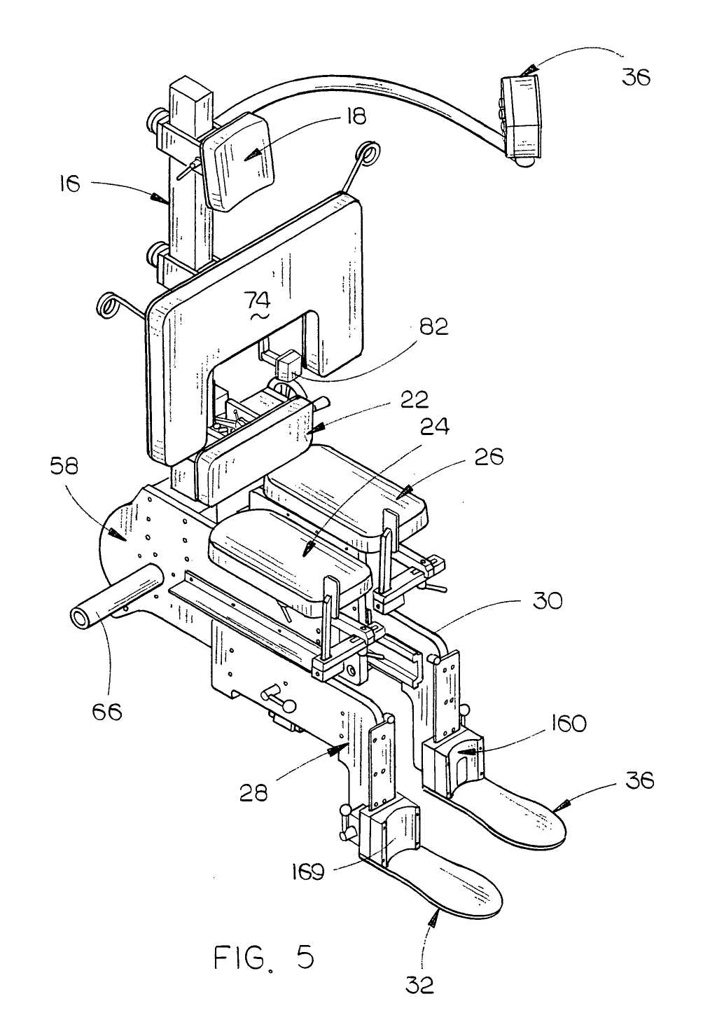

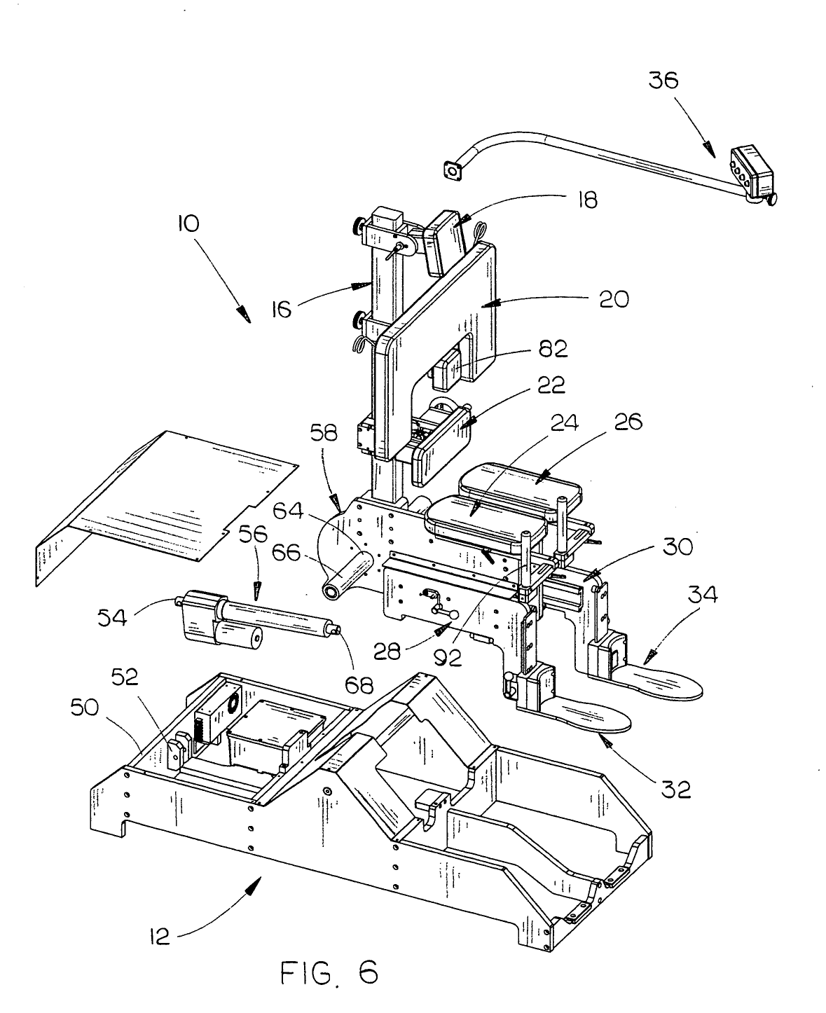

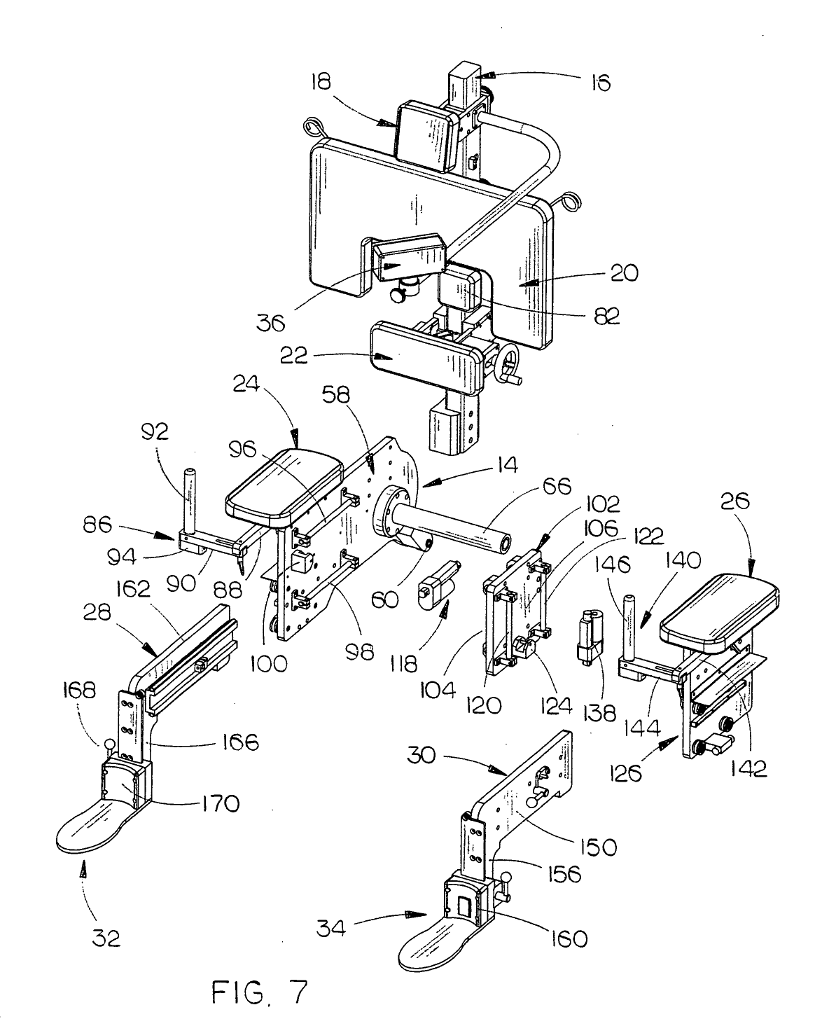

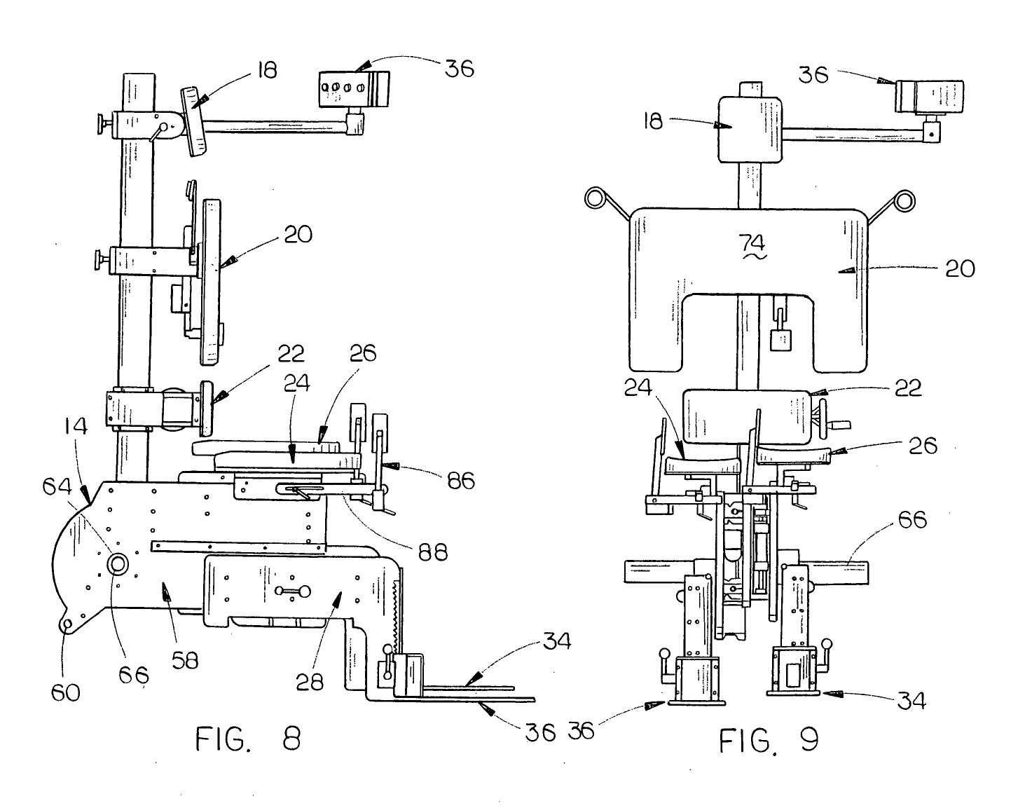

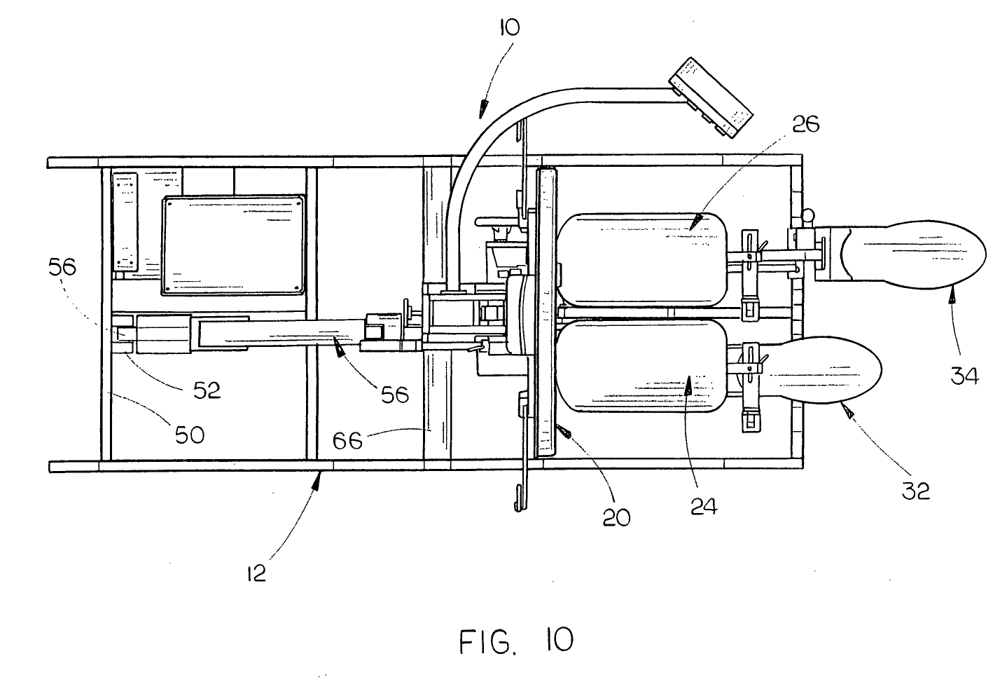

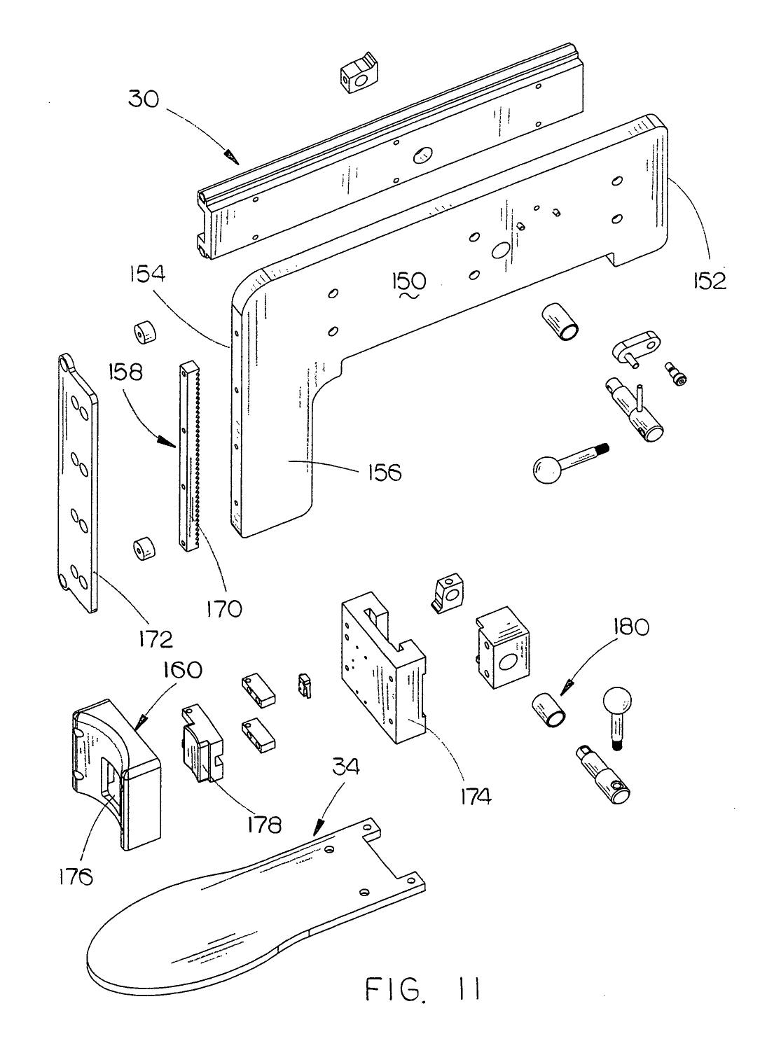

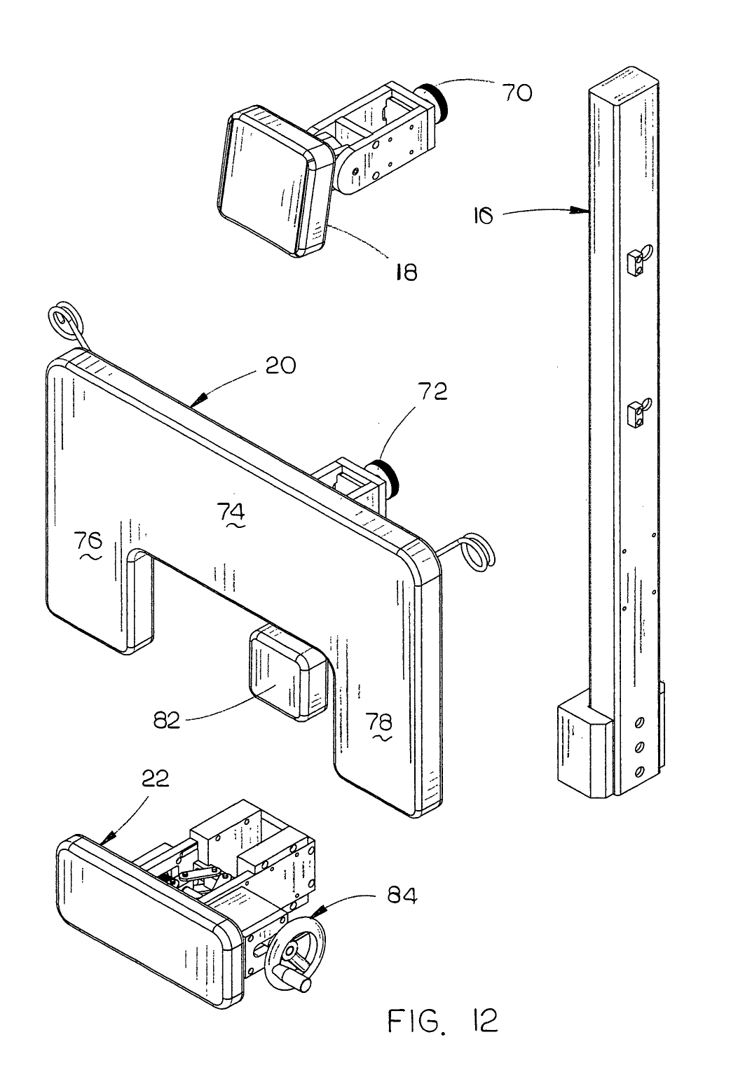

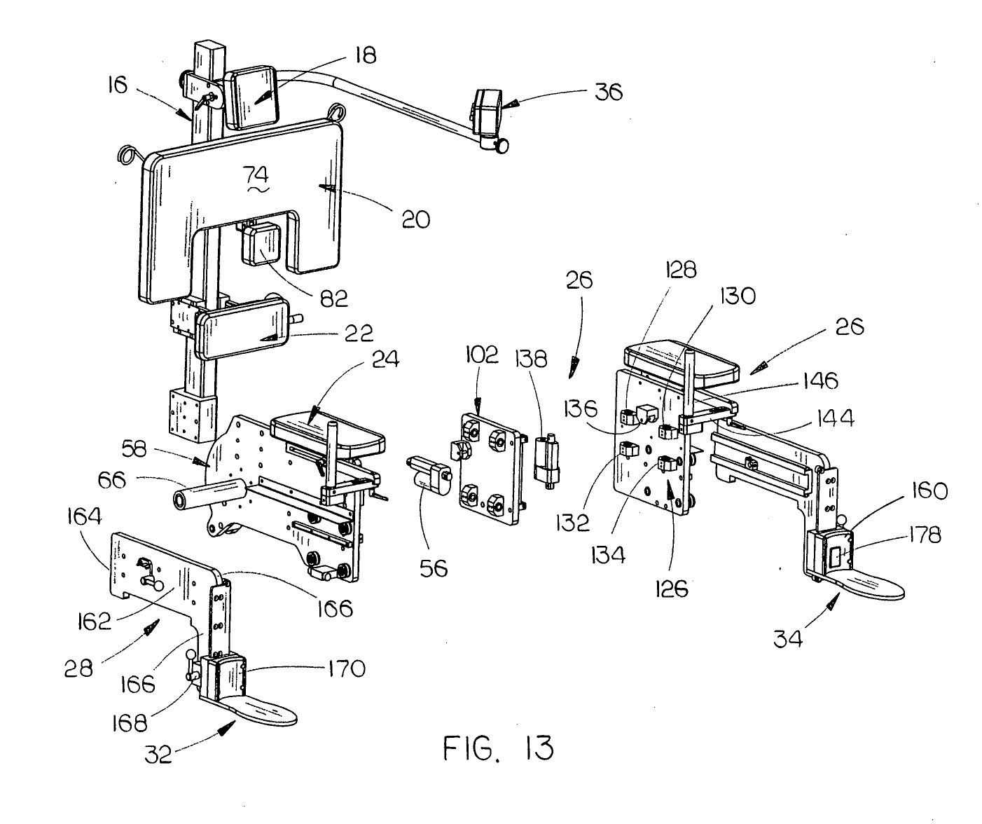

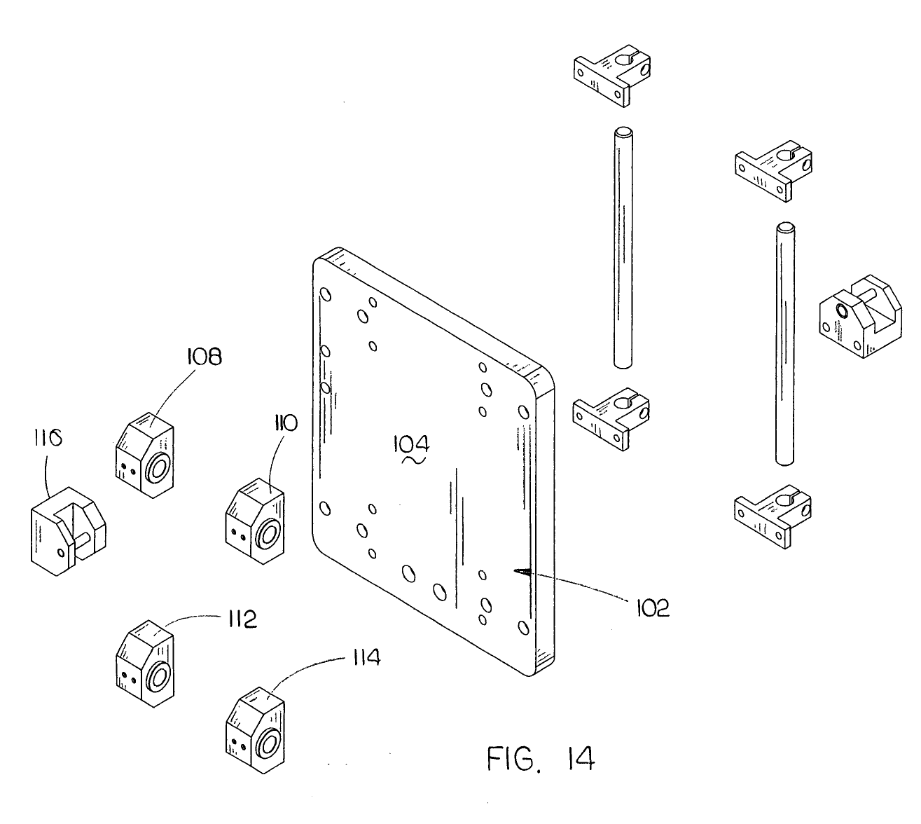

Patient chair frame means 14 includes a vertically disposed main tilt plate 58 which has an actuator pivot pin opening 60 formed in its lower rearward end adapted to receive an actuator pivot pin 62 therein. Tilt plate 58 also has a pivot opening 64 formed therein which has a shaft 66 extending therethrough. The opposite ends of shaft 66 are pivotally or rotatably secured to the supports 46 and 48. The forward end 68 of screw actuator 56 is pivotally secured to tilt plate 58 by the pivot pin 62. The extension of actuator 56 causes the tilt plate 58 to pivotally move from its horizontally disposed first position (FIG. 1) to its generally vertically disposed second position (FIG. 2).

The lower end of support post 16 is secured to the left side of tilt plate 58 by bolts or screws and extends upwardly therefrom. Head rest 18 is selectively vertically movably secured to support post 16 by a clamping mechanism 70. Head rest 18 is also selectively pivotally movable about a transverse horizontal axis and is clamped into various positions by a clamping mechanism 71.

An upper back and arm support 20 is selectively vertically adjustably mounted on support post 16 by a clamping mechanism 72. Support 20 includes a back support portion 74, a right arm support portion 76 and a left arm support portion 78. As seen in FIG. 1, the right arm support portion 76 is spaced from the left arm support portion 78 to define an opening 80 therebetween. A sensor 82 is secured to the support 20 so as to be positioned in the opening 80.

Lower back support 22 is clamped onto the support post 16 so as to be positioned at the lower end of back and arm support 20. The support 22 is selectively horizontally adjustable with respect to support post 16 by a wheel operated slide assembly generally referred to by the reference numeral 84.

Right thigh support 24 is secured to the main tilt plate 58 at the right side thereof by screws or bolts which extend through bracket 87, which is secured to support 24, and through tilt plate 58. Left thigh support 26 is secured to the main tilt plate 58 at the left side thereof as will be described in more detail hereinafter. A sensor assembly 86 is secured to the right side of tilt plate 58 laterally outwardly of right thigh support 24. Sensor assembly 86 includes a first horizontally disposed support arm 88 which is longitudinally slidably adjustably secured to bracket 87. Sensor assembly 86 also includes a second horizontally disposed support arm 90 which extends transversely from the forward end of support arm 88 and which is transversely slidably adjustably secured thereto. A sensor lever 92 is pivotally secured to the outer end of support arm 90 and extends upwardly therefrom. A sensor 94 is associated with the lever 92 and senses the right adductor.

The attachment of left thigh assembly 26 is selectively vertically movable with respect to tilt plate 58 and is also selectively horizontally movable with respect to tilt plate 58. The left forward side of tilt plate 58 has a pair of vertically spaced-apart and horizontally extending rods 96 and 98 secured thereto. Bracket 100 is secured to tilt plate 58 between the forward ends of rods 98 and 100. The numeral 102 refers to a plate having an inner surface 104 and an outer surface 106. The inner side 104 of plate 103 has a pair of upper slide blocks 108 and 110 secured thereto and has a pair of lower slide blocks 112 and 114 secured thereto. Slide blocks 108 and 110 are slidably mounted on rod 96 and slide blocks 112 and 114 are slidably mounted on rod 98. The inner surface 104 of plate 102 has a bracket 116 secured thereto. An electrically driven screw actuator 118 has one end thereto secured to bracket 100 on tilt plate 58 and its other end secured to bracket 116 on plate 102 to enable plate 102 to be slidably moved forwardly or rearwardly with respect to tilt plate 58. The outer side 106 of plate 102 has a pair of vertically disposed rods 120 and 122 secured thereto which are horizontally spaced with respect to one another. The outer side 106 of plate 102 also has a bracket 124 secured thereto.

Assembly 26 also includes a vertically disposed plate 126 having inner and outer sides. The inner side of plate 126 has a pair of upper slide blocks 128 and 130 secured thereto. The inner side of plate 126 also has a pair of lower slide blocks 132 and 134 secured thereto. Further, a bracket 136 is secured to the inner side of plate 126. Slide blocks 128 and 132 are slidably mounted on rod 122. Slide blocks 130 and 134 are slidably mounted on rod 120. An electrically operated screw actuator 138 has one end thereof connected to bracket 136 and its other end connected to bracket 124 so that plate 126 may be selectively vertically moved upwardly and downwardly with respect to plate 102.

A sensor assembly 140 is secured to the outer side of plate 126 as seen in the drawings. Assembly 140 includes a first horizontally disposed support arm 142 which is longitudinally slidably adjustably secured to plate 126. Assembly 140 also includes a second horizontally disposed support arm 144 which extends transversely from the forward end of support arm 144 and which is transversely slidably adjustably secured thereto. A sensor lever 146 is pivotally secured to the outer end of support arm 142 and extends upwardly therefrom. A sensor 148 is associated with the lever 102 as will be described hereinafter.

The sensor 148 is positioned at the interior of the left leg of the patient and facilitates the left adductor of the patient.

The left leg support 30 includes a vertically disposed and horizontally extending upper portion 150 having a rearward end 152 and a forward end 154. Left leg support 30 also includes a vertically disposed portion 156 which extends downwardly from the forward end of upper portion 150. Foot support 34 is selectively vertically adjustably mounted on the lower end of portion 156 by means of an apparatus 158 which will be described in more detail hereinafter. Foot support 34 includes a heel support 160 which will also be described in more detail hereinafter.

The right leg support 28 includes a vertically disposed upper portion 162 having a rearward end 164 and a forward end 166. Right leg support 28 also includes a vertically disposed portion 166 which extends downwardly from the forward end of upper portion 162. Foot support 32 is selectively vertically adjustably mounted on the lower end of portion 166 by means of an adjustment apparatus 168. Foot support 32 includes a heel support 169.

Adjustment apparatus 158 includes a rack 170 which is secured to the forward end of portion 156 of right leg support 28. A slide plate 172 is selectively vertically movably positioned forwardly of rack 170 and has a slide block 174 secured to the lower end thereof. Heel support 160 is secured to the forward side of slide block 174 for movement therewith. Heel support 160 has a central opening 176 formed therein which has a sensor 178 positioned therein. The slide plate 172, slide block 174 and heel support 160 are selectively vertically movably adjusted with respect to rack 170 and held in position by a release lever assembly. Adjustment apparatus 168 is identical to adjustment apparatus 158 and will not be described in detail.

The numeral 180 refers to a cover which is mounted on the upper end of the base frame means.

In use, the main tilt plate 58 will initially be in the position of FIG. 1. In the position of FIG. 1, the head rest 18, back and arm support 20, and lower back support 22 will be in a generally vertically disposed position. At the same time, right thigh support 24, left thigh support 26, and foot supports 32 and 34 will be generally horizontally disposed. When the patient has been seated in the chair, the head rest 18 and back and arm support 20 will be vertically adjusted to fit the patient. At that time, lower back support 22 will be horizontally adjusted to fit the patient. Also at that time, the supports 24, 26, 32 and 34 will be adjusted to fit the patient.

The actuator 56 is then operated to cause the chair to be pivotally moved from the position of FIG. 1 to the position of FIG. 2. In the position of FIG. 2, the patient will be in a generally supine position with the patient's legs being elevated. The patient will then be encouraged to exert pressure on the sensors.

When the patient is in the position of FIG. 2, it is the best position to allow for inhibition of back extensions and to inhibit normal pattern. Further, it puts the patient into an anti-gravity position. Additionally, it places the patient in a position to allow the patient to achieve a zone of opposition. Further, it allows for facilitation of hamstring to reposition the patient's pelvis without compensation. Further, it allows a patient to neurologically feel inhibition of normal human pattern.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A restorator chair, comprising:
a generally horizontally disposed and elongated base frame assembly including a lower end, an upper end, a forward end, a rearward end, a right side and a left side;
a patient chair frame means secured to said base frame assembly;
said patient chair frame means having a lower end, an upper end, a rearward end, a forward end, a right side and a left side;
said patient chair frame means being pivotally secured, about a transverse horizontal axis, to said base frame intermediate said forward and rearward ends of said base frame;
an elongated support post having a lower end, an upper end, a forward side and a rearward side;
said support post being secured at said lower end thereof to said patient chair frame means and extending upwardly therefrom;
a head rest selectively vertically adjustably secured to said support post adjacent said upper end thereof at said forward side thereof;
a back and arm rest, having upper and lower ends, selectively vertically adjustably secured to said support post below said head rest and spaced therefrom at said forward side of said support post;
a lower back support selectively horizontally secured to said support post at said lower end of said back and arm rest and spaced therefrom at said forward side of said support post;
a generally horizontally disposed right thigh support secured to said patient chair frame means at said right side thereof so as to be positioned below said lower back support;
a generally horizontally disposed left thigh support secured to said patient chair frame means at said left side thereof so as to be positioned below said lower back support;
a right leg support assembly including a generally horizontally disposed upper portion, having forward and rearward ends, and a generally vertically disposed portion, having upper and lower ends, extending downwardly from said forward end of said generally horizontally disposed upper portion thereof;
said generally horizontally disposed upper portion of said right leg support assembly being selectively longitudinally horizontally adjustably secured to said patient chair frame means at said right side thereof so as to extend forwardly therefrom;
a right foot plate assembly including a right foot plate selectively vertically adjustably secured to said vertically disposed' portion of said right leg support assembly so as to extend forwardly therefrom;
said right foot plate having a heel support associated therewith;
a left leg support assembly including a generally horizontally disposed upper portion, having forward and rearward ends, and a generally vertically disposed portion, having upper and lower ends, extending downwardly from said forward end of said generally horizontally disposed upper portion thereof;
said generally horizontally disposed upper portion of said left leg support assembly being selectively longitudinally horizontally adjustably secured to said patient chair frame means at said left side thereof so as to extend longitudinally forwardly therefrom;
a left foot plate assembly including a left foot plate selectively vertically adjustably secured to said vertically disposed portion of said left leg support assembly so as to extend longitudinally forwardly therefrom;
said left foot plate having a heel support associated therewith;
an electrically operated, length adjustable actuator, having first and second ends, which is movable between extended and retracted positions;
said first end of said actuator being pivotally secured, about a transverse horizontal axis to said base frame assembly;
said second end of said actuator being pivotally secured, about a transverse horizontal axis, to said patient chair frame means;
said patient chair frame means being in a first position when said actuator is in said retracted position;
said patient chair frame means being in a second position when said actuator is in said extended position;
said support post, said head rest, said back and arm rest and said lower back support being generally vertically disposed when said patient chair frame means is in said first position;
said right thigh support, said left thigh support, said right foot plate and said left foot plate being generally horizontally disposed when said patient chair frame means is in said first position;
said support post, said head rest, said back and arm rest and said lower back support being generally horizontally disposed when said patient chair frame means is in said second position;
said right thigh support, said left thigh support, said right foot plate and said left foot plate being generally vertically disposed when said patient chair frame means is in said second position;
a first pressure sensitive sensor associated with said back and arm rest;
a second pressure sensitive sensor associated with said right thigh support;
a third pressure sensitive sensor associated with said left thigh support;
a fourth pressure sensitive sensor associated with said left heel support; and
a visual indicator secured to said patient chair frame means which indicates whether said first, second, third and fourth sensors have been actuated by a patient applying pressure thereto.

2. The structure of Claim wherein said visual indicator is positioned so as to be visible to the patient.

3. The structure of claim 1 wherein said left thigh support is selectively vertically adjustably secured to said patient chair frame means.

4. The structure of claim 3 wherein said left thigh support is also selectively horizontally adjustably secured to said patient chair frame means.

5. A restorator chair, comprising:
a generally horizontally disposed and elongated base frame assembly including a lower end, an upper end, a forward end, a rearward end, a right side and a left side;
a patient chair frame means secured to said base frame assembly;
said patient chair frame means having a lower end, an upper end, a rearward end, a forward end, a right side and a left side;
said patient chair frame means being pivotally secured, about a transverse horizontal axis, to said base frame intermediate said forward and rearward ends of said base frame;
an elongated support post having a lower end, an upper end, a forward side and a rearward side;
said support post being secured at said lower end thereof to said patient chair frame means and extending upwardly therefrom;
a head rest selectively vertically adjustably secured to said support post adjacent said upper end thereof at said forward side thereof;
a back and arm rest, having upper and lower ends, selectively vertically adjustably secured to said support post below said head rest and spaced therefrom at said forward side of said support post;
a lower back support selectively horizontally secured to said support post at said lower end of said back and arm rest and spaced therefrom at said forward side of said support post;
a generally horizontally disposed right thigh support secured to said patient chair frame means at said right side thereof so as to be positioned below said lower back support;
a generally horizontally disposed left thigh support secured to said patient chair frame means at said left side thereof so as to be positioned below said lower back support;
a right leg support assembly including a generally horizontally disposed upper portion, having forward and rearward ends, and a generally vertically disposed portion, having upper and lower ends, extending downwardly from said forward end of said generally horizontally disposed upper portion thereof;
said generally horizontally disposed upper portion of said right leg support assembly being selectively longitudinally horizontally adjustably secured to said patient chair frame means at said right side thereof so as to extend forwardly therefrom;
a right foot plate assembly including a right foot plate selectively vertically adjustably secured to said vertically disposed portion of said right leg support assembly so as to extend forwardly therefrom;
said right foot plate having a heel support associated therewith;
a left leg support assembly including a generally horizontally disposed upper portion, having forward and rearward ends, and a generally vertically disposed portion, having upper and lower ends, extending downwardly from said forward end of said generally horizontally disposed upper portion thereof;
said generally horizontally disposed upper portion of said left leg support assembly being selectively longitudinally horizontally adjustably secured to said patient chair frame means at said left side thereof so as to extend longitudinally forwardly therefrom;
a left foot plate assembly including a left foot plate selectively vertically adjustably secured to said vertically disposed portion of said left leg support assembly so as to extend longitudinally forwardly therefrom;
said left foot plate having a heel support associated therewith;
an electrically operated, length adjustable actuator, having first and second ends, which is movable between extended and retracted positions;
said first end of said actuator being pivotally secured, about a transverse horizontal axis to said base frame assembly;
said second end of said actuator being pivotally secured, about a transverse horizontal axis, to said patient chair frame means;
said patient chair frame means being in a first position when said actuator is in said retracted position;
said patient chair frame means being in a second position when said actuator is in said extended position;
said support post, said head rest, said back and arm rest and said lower back support being generally vertically disposed when said patient chair frame means is in said first position;
said right thigh support, said left thigh support, said right foot plate and said left foot plate being generally horizontally disposed when said patient chair frame means is in said first position;
said support post, said head rest, said back and arm rest and said lower back support being generally horizontally disposed when said patient chair frame means is in said second position;
said right thigh support, said left thigh support, said right foot plate and said left foot plate being generally vertically disposed when said patient chair frame means is in said second position;
a pressure sensitive sensor associated with one or more of said upper back and arm assemblies, said right thigh support, said left thigh support, said right heel support and said left heel support; and
a visual indicator secured to said patient chair frame means which indicates whether the one or more sensors have been actuated by a patient applying pressure thereto.

6. The combination of claim 5 wherein said visual indicator means is visible to a patient when said patient chair frame means is in said first and second positions.

7. The structure of claim 5 wherein said left thigh support is selectively vertically adjustably secured to said patient chair frame means.

8. The structure of claim 5 wherein said left thigh support is also selectively horizontally adjustably secured to said patient chair frame means.

9. A restorator chair, comprising;
a generally horizontally disposed and elongated base frame assembly including a lower end, an upper end, a forward end, a rearward end, a right side and a left side;
a patient chair frame means secured to said base frame assembly;
said patient chair frame means being pivotally secured, about a transverse horizontal axis, to said base frame intermediate said forward and rearward ends of said base frame;
an elongated support post having a lower end, an upper end, a forward side and a rearward side:
said support post being secured at said lower end thereof to said patient chair frame means and extending upwardly therefrom;
a head rest secured to said support post adjacent aid upper end thereof at said forward side thereof;
a back and arm rest secured to said support post below said head rest and spaced therefrom at said forward side of said support post;
a lower back support secured to said support post at said lower end of said back and arm rest and spaced therefrom at said forward side of said support post;
a generally horizontally disposed right thigh support secured to said patient chair frame means at said right side thereof so as to be positioned below said lower back support;
a generally horizontally disposed left thigh support secured to said patient chair frame means at said left side thereof so as to be positioned below said lower back support;
a right leg support assembly secured to said patient chair frame means;
a right foot plate secured to said right leg;
said right foot plate having a heel support associated therewith;
a left leg support assembly secured to said patient chair frame means;
a left foot plate secured to said left leg support assembly;
said left foot plate having a heel support associated therewith;
an electrically operated, length adjustable actuator, having first and second ends, which is movable between extended and retracted positions;
said first end of said actuator being pivotally secured, about a transverse horizontal axis to said base frame assembly;
said second end of said actuator being pivotally secured, about a transverse horizontal axis, to said patient chair frame means;
said patient chair frame means being in a first position when said actuator s in said retracted position;
said patient chair frame means being in a second position when said actuator in said extended position;
said support post, said head rest, said back and arm rest and said lower back support being generally vertically disposed when said patient chair frame means is in said first position;
said right thigh support, said left thigh support, said right foot plate and said left foot plate being generally horizontally disposed when said patient chair frame means is in said first position;
said support post, said head rest, said back and arm rest and said lower back support being generally horizontally disposed when said patient chair frame means is in said second position;
said right thigh support, said left thigh support, said right foot plate and said left foot plate being generally vertically disposed when said patient chair frame means is in said second position;
a first pressure sensitive sensor associated with said back and arm rest;
a second pressure sensitive sensor associated with said right thigh support;
a third pressure sensitive sensor associated with said left thigh support;
a fourth pressure sensitive sensor associated with said left heel support; and a visual indicator secured to said patient chair frame means which indicates whether said first, second, third and fourth sensors have been actuated by a patient applying pressure thereto.

10. The structure of claim 9 wherein said visual indicator is positioned so as to be visible to the patient.

11. The structure of claim 9 wherein said left thigh support is selectively vertically adjustably secured to said patient chair frame means.

12. The structure of claim 9 wherein said left thigh support is also selectively horizontally adjustably secured to said patient chair frame means.

13. The structure of claim 9 wherein said head rest is selectively vertically adjustably mounted on said support post.

14. The structure of claim 9 wherein said back and arm rest is selectively vertically adjustably mounted on said support post.

15. The structure of claim 9 wherein said right and left foot plates are selectively vertically adjustably mounted on said patient chair frame means.
